(19) United States
(12) Patent Application Publication
(10) Pub. No.: US 2025/0343375 A1
(43) Pub. Date: Nov. 6, 2025

(54) ELECTRICAL CONNECTOR

(71) Applicant: LOTES CO., LTD, Keelung (TW)

(72) Inventors: Zhi-Guo Peng, Guangzhou (CN); Qui-Shen Feng, Guangzhou (CN); Po-Jui Chou, Keelung (TW); Qing-Cheng Zeng, Guangzhou (CN)

(21) Appl. No.: 19/021,789

(22) Filed: Jan. 15, 2025

(30) Foreign Application Priority Data
May 2, 2024 (CN) 202410544160.6

(51) Int. Cl. H01R 13/6471; H01R 12/71; H01R 13/24; H01R 13/6591

(52) U.S. Cl. CPC H01R 13/6471; H01R 12/716; H01R 13/2457; H01R 13/65914

(57) ABSTRACT

An electrical connector includes a row of terminals including at least four terminal groups. Each terminal group is formed by a ground terminal and a pair of differential signal terminals or a single-ended signal terminal located at a side of the ground terminal, and along the left-right direction, the ground terminal and the pair of differential signal terminals or the single-ended signal terminal are arranged in an identical sequential order, and no ground terminal exists between each two of the terminal groups; and a grounding member. In the two ground terminals of each two of the terminal groups closest to each other, one of the two ground terminals is in electrical contact with the grounding member, and the other of the two ground terminals is electrically isolated from the grounding member, thereby optimizing the resonance and reducing the noise and interference.

### CROSS-REFERENCE TO RELATED PATENT APPLICATION

This non-provisional application claims priority to and the benefit of, pursuant to 35 U.S.C. § 119(a), patent application Serial No. CN 202410544160.6, filed in China on May 2, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to an electrical connector, and particularly to an electrical connector for resonance optimization.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

For an electrical connector serving as a transmission carrier in the realm of signal transmission, in the initial stage of design optimization, a technician in the art typically adopts a metal grounding member to serially connect all ground terminals in the electrical connector, thereby enhancing the shielding effect inside the electrical connector, reducing the noise and interference between signal terminals in the electrical connector, and improving the signal integrity (SI) performance of the electrical connector. However, this solution also introduces challenges. For the SI performance of the electrical connector, in addition to the noise and interference between the signal terminals, the resonance within the electrical connector emerges as a significant high frequency parameter that impacts the SI performance. To address this, the technician in the art generally explores modifications to the material of the metal grounding member (such as substituting it with a conductive plastic) or altering the width and thickness of the metal grounding member to optimize the resonance. However, the optimization outcome is often suboptimal due to constraints of the factors such as manufacturing cost of the electrical connector, internal structural complexity, and volume thereof.

Therefore, a heretofore unaddressed need to design a new electrical connector exists in the art to address the aforementioned deficiencies and inadequacies.

### SUMMARY

In view of the deficiencies of the background technology, the present invention is directed to an electrical connector, in which one of the two closest ground terminals is electrically connected and the other is electrically isolated by the pattern of the grounding member, thereby optimizing the overall resonance.

To achieve the foregoing objective, the present invention adopts the following technical solutions:

An electrical connector includes: an insulating body; a row of terminals, accommodated in the insulating body and comprising at least four terminal groups, wherein each terminal of the row of terminals has a contact portion configured to be in contact with a mating component, the contact portions of the row of terminals are arranged side-by-side in a left-right direction, each of the terminal groups is formed by a ground terminal and a pair of differential signal terminals or a single-ended signal terminal located at a side of the ground terminal, and along the left-right direction, the ground terminal and the pair of differential signal terminals or the single-ended signal terminal are arranged in an identical sequential order, and no ground terminal exists between each two of the terminal groups; and a grounding member, wherein in the two ground terminals of each two of the terminal groups closest to each other, one of the two ground terminals is in electrical contact with the grounding member, and the other of the two ground terminals is electrically isolated from the grounding member.

In certain embodiments, the four terminal groups are arranged along the left-right direction as one ground terminal, one pair of differential signal terminals, one ground terminal, one pair of differential signal terminals, one ground terminal, one pair of differential signal terminals, one ground terminal, and one pair of differential signal terminals, and no terminal exists between each two of the terminal groups.

In certain embodiments, the grounding member has a plurality of elastic arms and a base directly connected to the elastic arms, the insulating body is provided with a plurality of slots at positions corresponding to the elastic arms, the elastic arms are one-to-one correspondingly accommodated in the slots, each of the elastic arms has an abutting region configured to abut against the ground terminal, and a width of each of the slots reduces in a direction from one end of each of the elastic arms connected to the base toward the abutting region.

In certain embodiments, an inner wall of the insulating body is provided with a plurality of protruding ribs, the grounding member comprises an elastic arm and a base directly connected to the elastic arm, the elastic arm abuts against the ground terminal, the protruding ribs are located at a side of the base away from the ground terminal, and the protruding ribs abut against the base toward the ground terminal.

In certain embodiments, the ground terminal comprises a main body, an elastic portion bending and extending from one side of the main body and a pin formed by bending and extending from another side of the main body, the contact portion is provided on the elastic portion, the pin is electrically connected to a printed circuit board (PCB), the ground terminal has only a contact region electrically connected to the grounding member, and the contact region is located on the elastic portion.

In certain embodiments, each of the terminal groups is formed by the ground terminal and the pair of differential signal terminals, the signal terminals of each of the terminal groups are a pair of differential signal terminals, the grounding member comprises a main body and a shielding portion formed by extending from the main body, the insulating body comprises a terminal slot accommodating the pair of differential signal terminals and an accommodating slot accommodating the shielding portion, a through hole communicating the accommodating slot and the terminal slot and two protruding portions respectively located at a left side and a right side of the through hole exist between the accommodating slot and the terminal slot, and a portion of the pair of differential signal terminals and a portion of the shielding portion overlap with the through hole vertically.

In certain embodiments, the grounding member is provided with a through slot and a position limiting portion provided to be elastic and protrude from a peripheral wall of the through slot toward an inner portion of the through slot, the insulating body comprises a position limiting block, the position limiting block is accommodated in the through slot and abuts against the position limiting portion, and the position limiting block is liquefied such that the position limiting block after cooling and solidification limits the grounding member from moving along a vertical direction and a front-rear direction.

In certain embodiments, the insulating body has a recess, each of the pair of differential signal terminals has an exposing portion located in a same one of the recess, and the grounding member correspondingly shields the two exposing portions of the pair of differential signal terminals.

Another technical solution of the present invention includes:

An electrical connector includes: an insulating body; a grounding member; and a row of terminals, accommodated in the insulating body arranged side-by-side in a left-right direction, wherein the row of terminals comprise a plurality of terminal sets, each of the terminal sets has two ground terminals at outer edges in the left-right direction and at least one signal terminal in a middle thereof, and along the left-right direction, the two ground terminals and the at least one signal terminal of each of the terminal sets are arranged in an identical sequential order; wherein the grounding member is serially connected to a plurality of the ground terminals in the row of terminals, and in the two ground terminals of each of the terminal sets at the outer edges in the left-right direction, one of the two ground terminals is in electrical contact with the grounding member, and the other of the two ground terminals is electrically isolated from the grounding member.

In certain embodiments, the grounding member has a plurality of elastic arms and a base directly connected to the elastic arms, the insulating body is provided with a plurality of slots at positions corresponding to the elastic arms, the elastic arms are one-to-one correspondingly accommodated in the slots, each of the elastic arms has an abutting region configured to abut against the ground terminal, and a width of each of the slots reduces in a direction from one end of each of the elastic arms connected to the base toward the abutting region.

In certain embodiments, the grounding member comprises a main body, the main body comprises a first portion and a second portion formed by extending from the first portion, the first portion has at least one step surface facing downward, the second portion has a side end surface facing toward at least one side in the left-right direction, the insulating body has a position limiting protrusion, the side end surface limits the position limiting protrusion from moving along the left-right direction, and the step surface limits the position limiting protrusion from moving upward.

In certain embodiments, the insulating body has a recess, the at least one signal terminal of each of the terminal sets includes a pair of differential signal terminals, each of the pair of differential signal terminals has an exposing portion located in a same one of the recess, and the grounding member correspondingly shields the two exposing portions of the pair of differential signal terminals.

In certain embodiments, the at least one signal terminal of each of the terminal sets includes a pair of differential signal terminals, the grounding member comprises a main body and a shielding portion formed by extending from the main body, the insulating body comprises a terminal slot accommodating the pair of differential signal terminals and an accommodating slot accommodating the shielding portion, a through hole communicating the accommodating slot and the terminal slot and two protruding portions respectively located at a left side and a right side of the through hole exist between the accommodating slot and the terminal slot, and a portion of the pair of differential signal terminals and a portion of the shielding portion overlap with the through hole vertically.

In certain embodiments, the grounding member is provided with a through slot and a position limiting portion provided to be elastic and protrude from a peripheral wall of the through slot toward an inner portion of the through slot, the insulating body comprises a position limiting block, the position limiting block is accommodated in the through slot, and the position limiting block abuts against the position limiting portion to limit the position limiting portion from moving.

In certain embodiments, the at least one signal terminal of each of the terminal sets includes a pair of differential signal terminals, the row of terminals are arranged in the sequential order along the left-right direction as one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, and one ground terminal.

Compared to the related art, the present invention has the following beneficial effects:

In the electronics field, according to the transmission needs, the electrical connector is used to perform signal transmissions within a target frequency range, and to prevent from unwanted resonant interference within the target frequency range (generally the resonant interference is generated by the grounding module, and is hereinafter referred to as the grounding module resonance), the present invention reduces the resonance and reduces the interference between the signals by adjusting the structure of the grounding module, which will be described hereinafter in details. When the wavelength of the electrical connector at a specific frequency is an odd multiple of a quarter wavelength of the target frequency, the grounding module resonance occurs, and the grounding module resonance prevents the electrical connector from filtering out the noise and interference generated by the grounding module resonance at the signal receiving end. In the present invention, one of the two ground terminals of each of two closest terminal pairs is electrically connected to the grounding member, thereby adjusting the resonant frequency outside the target frequency range and eliminating the grounding module resonance. Further, in the present invention, the other of the two ground terminals in each of the two closest terminal pairs is electrically isolated from the grounding member. In other words, of the ground terminals located at the left side and the right side of a pair of differential signal terminals or a single-ended signal terminal, one is electrically connected to the grounding member, and the other is electrically isolated from the grounding member. Thus, the noise and interference caused by the electric field and the magnetic field generated by the tiny currents and voltages on the ground terminals do not concentrate on the pair of differential signal terminals or the single-ended signal terminal, and the interference experienced by the pair of differential signal terminals or the single-ended signal terminal is correspondingly reduced, thus optimizing the high frequency characteristics of the electrical connector and enhancing the signal completeness of the electrical connector. In addition, one of the two ground terminals of each of two closest terminal pairs is electrically connected to the grounding member and the other is electrically isolated from the grounding member, such that the electrical connection and electrical isolation between the grounding member and the ground terminals in the left-right direction are regular and periodic, thereby resulting in a more uniform distribution of the electric field and the magnetic field generated by the ground terminals and the grounding member within the electrical connector, and optimizing the overall resonance of the electrical connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of an electrical connector according to certain embodiments of the present invention.

FIG. 2 is a plain view of an electrical connector according to certain embodiments of the present invention.

FIG. 3 is a sectional view of FIG. 2 along a line A-A.

FIG. 4 is a sectional view of FIG. 2 along a line B-B.

FIG. 5 is a sectional view of FIG. 2 along a line C-C.

FIG. 6 is a perspective view of a row of terminals with an insulating member according to certain embodiments of the present invention.

FIG. 7 is an enlarged view of a location D in FIG. 6.

FIG. 8 is a partial schematic view of a row of terminals with an insulating member in FIG. 6.

FIG. 9 is a perspective view of an insulating shell according to certain embodiments of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

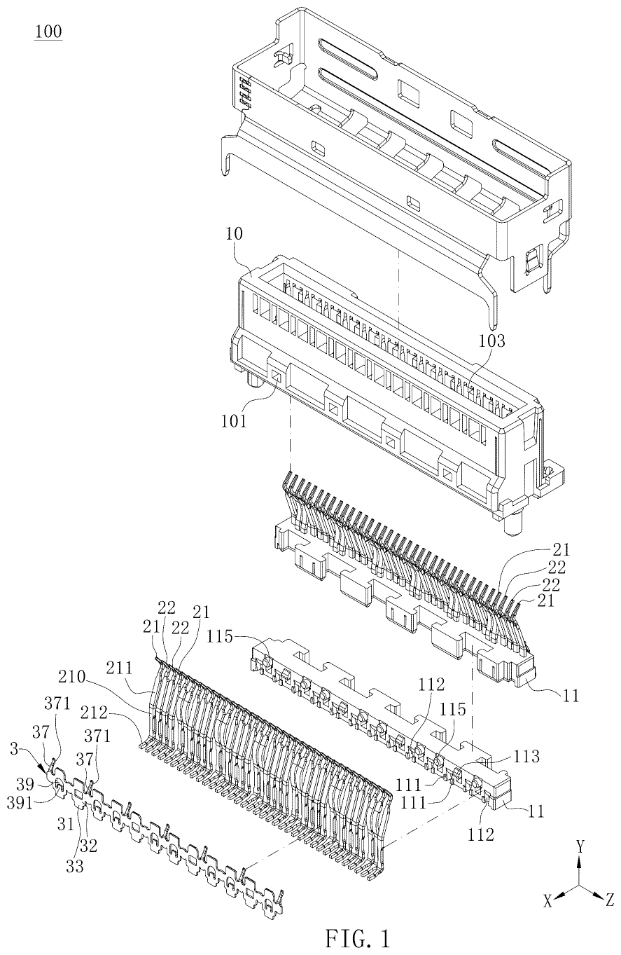

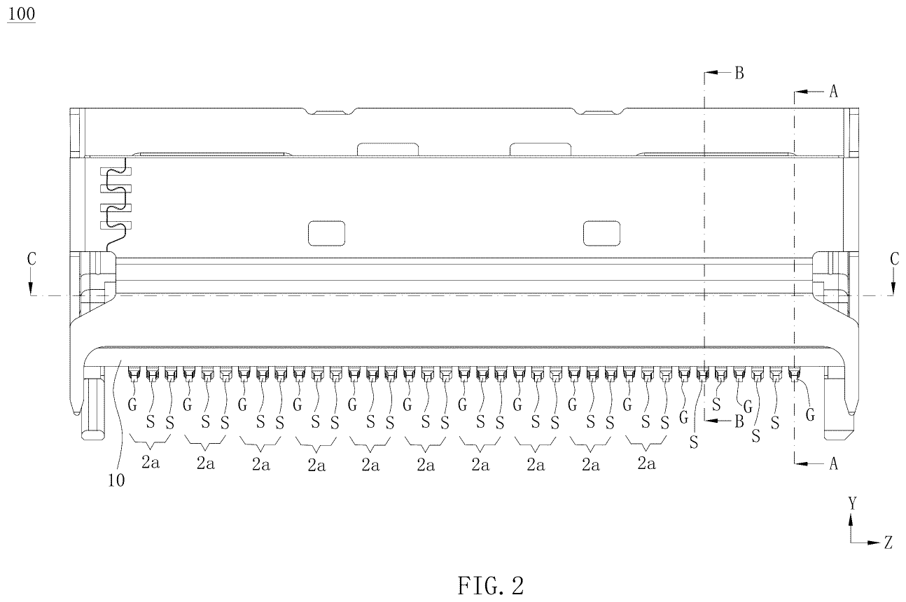

The description will be made as to the embodiments of the present invention in conjunction with the accompanying drawings in FIGS. 1-9. In accordance with the purposes of this invention, as embodied and broadly described herein, this invention, in one aspect, relates to an electrical connector assembly with an electrical connector.

As shown in FIG. 1 to FIG. 9, in an electrical connector 100 according to certain embodiments of the present invention, a front-rear direction is defined as the X-axis, a vertical direction is defined as the Y-axis, and a left-right direction is defined as the Z-axis. It should be noted that the directions of up, down, left and right are merely provided for understanding of the embodiments of the present invention, without limiting the present invention thereto. The electrical connector 100 according to certain embodiments of the present invention may be any type of an upright connector, a horizontal connector or a right-angle connector.

As shown in FIG. 1, the electrical connector 100 includes an insulating body 1, signal terminals 22 and ground terminals 21 accommodated in the insulating body 1, and a grounding member 3. The signal terminals 22 and the ground terminals 21 are provided as a row of terminals arranged side-by-side in the left-right direction. The insulating body 1 includes an insulating shell 10 and an insulating member 11, and the insulating shell 10 and the insulating member 11 are both formed by insulating plastic materials. the insulating shell 10 and the insulating member 11 may be made of the same material, or may be made of different materials, and the prevent invention is not limited thereto. The insulating member 11 is integrally formed outside the row of terminals and is accommodated in the insulating shell 10. The grounding member 3 is formed by a conductive material, such as metal or conductive plastic, and the grounding member 3 is used to be in contact with and serially connected to some of the ground terminals 21, thereby grounding the ground terminals 21.

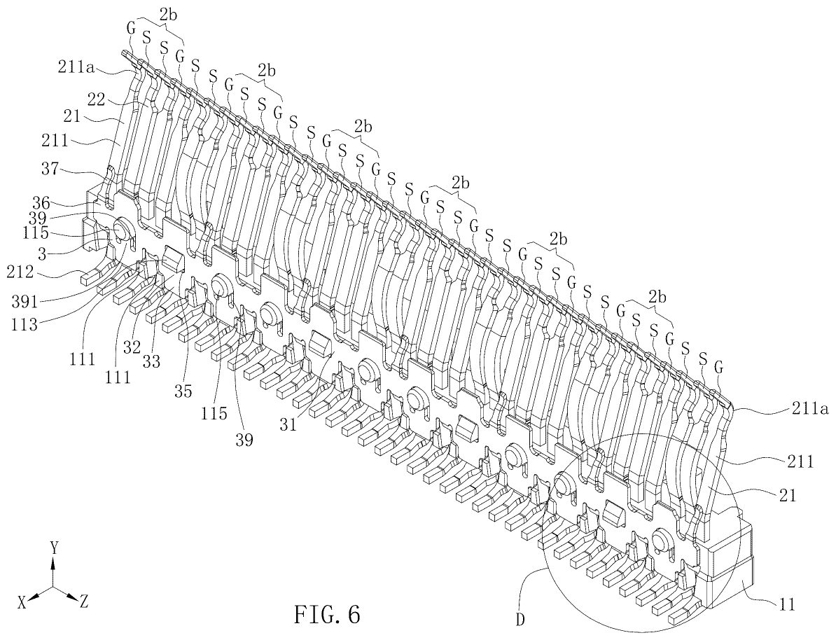

As shown in FIG. 6 to FIG. 8, each ground terminal 21 includes a body portion 210, an elastic portion 211 bending and extending from one side of the body portion 210 and a pin 212 formed by bending and extending from another side of the body portion 210. The elastic portion 211 includes a contact portion 211a used to abut forward against a mating component. The mating component may be a mating printed circuit board (PCB) or a mating connector, and the present invention is not limited thereto. The pin 212 may be electrically connected to the PCB (not shown) by regular technical solutions such as surface-mount technology (SMT), dual in-line package (DIP), elastic abutting or press-fit, and if DIP is adopted, the pin 212 may be formed without bending and extending.

As shown in FIG. 6, terminal groups 2a are defined, and each row of terminals include four or more terminal groups 2a. Each terminal group 2a is formed by a ground terminal 21 and signal terminals 22 located at a side of the ground terminal 21. It should be noted that the signal terminals 22 may be a pair of differential signal terminals, or may be a single-ended signal terminal. In other words, if G represents a ground terminal 21 and S represents a signal terminal 22, in a row of terminals, the arrangement of the signal terminals 22 and the ground terminals 21 from the left to the right may be GSS-GSS-GSS-GSS or GS-GS-GS-GS. It should be noted that the individual component in front of or behind the symbol “-” corresponds to a terminal group 2a, “SS” represents a pair of differential signal terminals, and “S” represents a single-ended signal terminal. It should be noted that only four terminal groups 2a are shown here, but more may be provided.

As shown in FIG. 6, terminal sets 2b may be defined, and each row of terminals include a plurality of terminal sets 2b. Each terminal set 2b has two ground terminals 21 at two outer edges in the left-right direction and signal terminals 22 in a middle thereof. It should be noted that, a terminal set 2b includes only the two ground terminals 21 at the two outer edges in the left-right direction and the signal terminals 22 between the two ground terminals 21. In other words, in the terminal set 2b, there is no additional ground terminal 21 except for the two ground terminals 21 at the two outer edges. For example, if G represents a ground terminal 21 and S represents a signal terminal 22, the terminal set 2b may be GSSG, GSG or GSSSG, etc., but may not be GGSSGG, GGSGG, GGSSSGG, GSSGG or GSSGS. Further, for example, if a row of terminals are in a sequence of, from the left to the right, GSSG-SS-GSSG-SS-GSSG, the row of terminals include three terminal sets 2b as “GSSG” and a pair of differential signal terminals “SS” are provided between each two terminal sets 2b. It is also possible to remove the differential signal terminals “SS” between the terminal sets 2b.

The term “terminal group 2a” as used herein refers to a group of terminals in the row of terminals, and the term “terminal set 2b” as used herein refers to a set of terminals in the row of terminals. It should be noted that the terms “terminal group” and “terminal set” are used to represent the embodiments in which the row of terminals are divided in different ways (i.e., “groups” or “sets”), and each terminal group and each terminal set may include terminals in different types (e.g., signal terminals or ground terminals), with different quantities of terminals in each type, and/or in different sequential orders. In certain embodiments, the row of terminals may include a plurality of terminal groups 2a. In certain embodiments, the row of terminals may include a plurality of terminal sets 2b. Alternatively, in certain embodiments, it is possible that the row of terminals may include a plurality of terminal groups 2a and a plurality of terminal sets 2b.

Referring to FIG. 6, which shows a row of terminals, which are arranged in the sequential order along the left-right direction as one ground terminal 21, one pair of differential signal terminals, one ground terminal 21, one pair of differential signal terminals, one ground terminal 21, one pair of differential signal terminals, one ground terminal 21, one pair of differential signal terminals, one ground terminal 21, one pair of differential signal terminals, one ground terminal 21, one pair of differential signal terminals, one ground terminal 21, one pair of differential signal terminals, one ground terminal 21, one pair of differential signal terminals, one ground terminal 21, one pair of differential signal terminals, one ground terminal 21, one pair of differential signal terminals, one ground terminal 21, one pair of differential signal terminals, one ground terminal 21, one pair of differential signal terminals, and one ground terminal 21.

The aforementioned row of terminals, if divided into the terminal groups 2a, are represented as GSS-GSS-GSS-GSS-GSS-GSS-GSS-GSS-GSS-GSS-GSS-GSS-GSS-G. The last ground terminal 21, which is individually provided, is to ensure that the right side of the pair of signal terminals 22 may be shielded by the ground terminal 21, thereby reducing the noise and interference when transmitting signals, and the technician in the art may provide the ground terminal 21 according to the needs. It should be noted that, in the example as described, no terminal, including the differential signal terminal, the single-ended signal terminal, the ground terminal 21, a power terminal or a detection terminal, exists between each two terminal groups 2a (and in other embodiments, it is possible to provide a signal terminal, a power terminal or a detection terminal between the two closest terminal groups 2a according to the needs, but no ground terminal 21 exists therebetween).

The aforementioned row of terminals, if divided into the terminal sets 2b, are represented as GSSG-SS-GSSG-SS-GSSG-SS-GSSG-SS-GSSG-SS-GSSG-SS-GSSG (with 7 terminal sets 2b) or GSS-GSSG-SS-GSSG-SS-GSSG-SS-GSSG-SS-GSSG-SS-GSSG-SSG (with 6 terminal sets 2b), in which the ground terminals 21 are connected in such a way to ensure that, for each terminal set 2b, in the two ground terminals 21 closest to the left side and the right side the pair of differential signal terminals, one is connected to the grounding member 3, and the other is not connected to the grounding member 3.

In other embodiments, a row of terminals may be divided into the terminal sets 2b as G-GSSG-GSSG-GSSG-GSSG-GSSG-GSSG-GSSG-G (with 7 terminal sets 2b, and the quantity of the terminal sets 2b may be increased or reduced according to the needs), in which the connecting of the two ground terminals 21 and the grounding member 3 in each terminal set 2b is identical to the aforementioned example, as long as it is ensured that, for each terminal set 2b, in the two ground terminals 21 closest to the left side and the right side the pair of differential signal terminals, one is electrically connected to the grounding member 3, and the other is electrically isolated from the grounding member 3.

As shown in FIG. 6, for the terminal groups 2a, in the two ground terminals 21 of each two of the terminal groups 2a closest to each other, the grounding member 3 is electrically connected to one of the two ground terminals 21 and electrically isolated from the other thereof. For example, in the arrangement of GSS-GSS-GSS-GSS, for convenience of understanding, the four terminal groups 2a are numbered as, from left to right, the terminal group 2aA-the terminal group 2aB-the terminal group-2aC-the terminal group 2aD, and the grounding member 3 is electrically connected to the ground terminals 21 in the terminal group 2aA and the terminal group 2aC, and is electrically isolated from the ground terminals in the terminal group 2aB and the terminal group 2aD.

For the terminal sets 2b, in the two ground terminals 21 at the two outer edges in the left-right direction, one of the two ground terminals 21 is electrically connected to the grounding member 3, and the other thereof is electrically isolated from the grounding member 3. For example, in the arrangement of GSSG-SS-GSSG-SS-GSSG, the ground terminals 21 in each terminal set 2b are numbered, that is, G₁SSG₂-SS-G₁SSG₂-SS-G₁SSG₂, and the electrical connection may be done by selectively electrically connecting the ground terminal G₁ to the grounding member 3 in the leftmost terminal set 2b of the three terminal sets 2b, and the ground terminal G₂ is electrically isolated from the grounding member 3. It is also possible that the ground terminal G₁ is electrically isolated from the grounding member 3, and the ground terminal G₂ is electrically connected to the grounding member 3. Similarly, in the three terminal sets 2b, the ground terminals G₁ and G₂ in the terminal set 2b at the middle and the rightmost terminal set 2b may be provided in a similar way, and are thus not hereinafter reiterated.

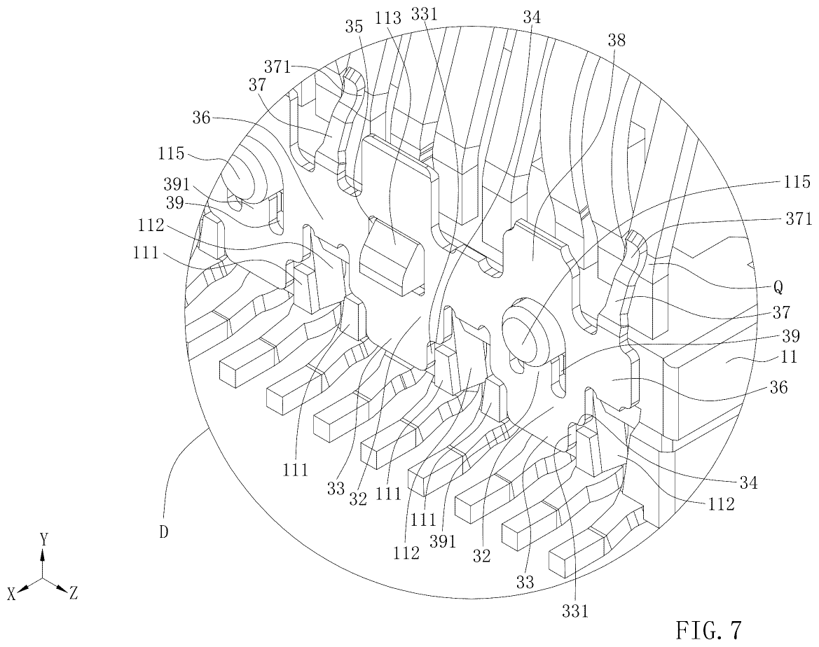

As shown in FIG. 1, FIG. 6 and FIG. 7, the grounding member 3 includes a main body 31, a plurality of bases 36 integrally connected to the main body 31 and a plurality of elastic arms 37 formed by extending from the bases 36. Each base 36 is provided to correspond to the position of a ground terminal 21, and an elastic arm 37 is formed by extending upward from the base 36. The elastic arm 37 has an abutting region 371, and the abutting region 371 is used to abut against the corresponding ground terminal 21, thereby forming a contact region Q. In other words, a ground terminal 21 has only one contact region Q to be electrically connected to the grounding member 3. The contact region Q may be located on the elastic portion 211, or the contact region Q may be located on the body portion 210 of the ground terminal 21. The direction of the elastic arms 37 may be altered. For example, the elastic arms 37 of the grounding member 3 may be all formed by extending downward from the bases 36, or may be all formed by extending upward from the bases 36. Alternatively, some of the elastic arms 37 may be formed by extending upward from the bases 36, and some may be formed by extending downward from the bases 36. It should be noted that the grounding member 3 is provided with the elastic arms 37 merely corresponding to the ground terminals 21 of the terminal groups 2a that are electrically connected thereto. For the terminal groups 2a electrically isolated from the grounding member 3, the grounding member 3 does not provide with corresponding elastic arms 37 to abut against the ground terminals 21 in these terminal groups 2a.

As shown in FIG. 1, FIG. 6 and FIG. 7, the main body 31 includes a first portion 32 and a second portion 33 formed by extending from the first portion 32. The first portion 32 has at least one step surface 34 facing downward. In other words, a width of the first portion 32 along the left-right direction is greater than a width of the second portion 33 along the left-right direction 33, such that the step surface 34 is formed on the first portion 32. The second portion 33 has a side end surface 331 facing toward the left-right direction.

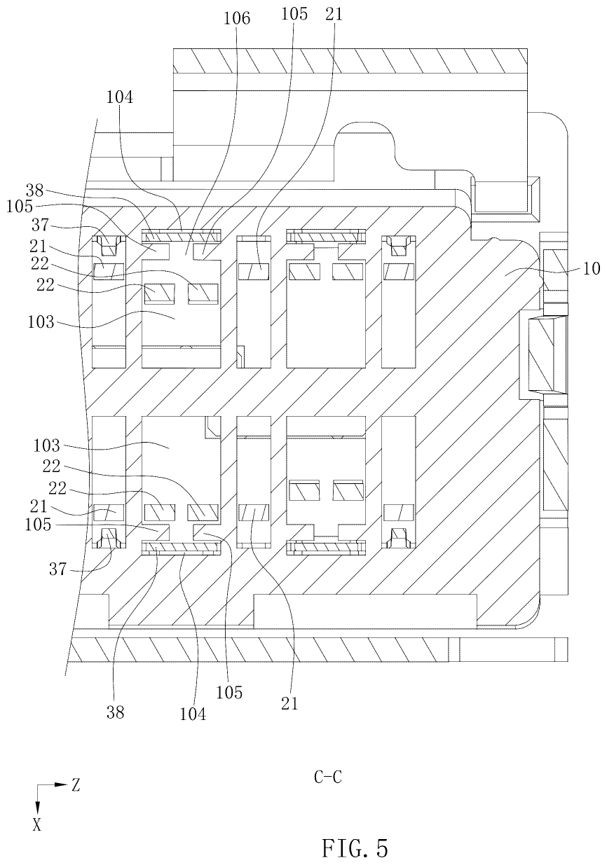

As shown in FIG. 1, FIG. 5 and FIG. 7, the grounding member 3 further includes a through slot 39, a position limiting portion 391 provided to be elastic and to protrude from a peripheral wall of the through slot 39 toward an inner portion of the through slot 39, and a shielding portion 38 formed by extending upward from the main body 31. The insulating shell 10 includes a terminal slot 103 accommodating the signal terminals 22 and an accommodating slot 104 accommodating the shielding portion 38. A through hole 106 communicating the accommodating slot 104 and the terminal slot 103 and two protruding portions 105 respectively located at a left side and a right side of the through hole 106 exist between the accommodating slot 104 and the terminal slot 103. Each protruding portion 105 is located between one signal terminal of the pair of differential signal terminals and the shielding portion 38. A portion of the pair of differential signal terminals and a portion of the shielding portion 38 overlap with the through hole 106 vertically.

As shown in FIG. 1, FIG. 6 and FIG. 7, the insulating body 11 has a position limiting protrusion 111, slots 112 and a position limiting block 115. The side end surface 331 of the second portion 33 limits the position limiting protrusion 111 from moving along the left-right direction, and the step surface 34 limits the position limiting protrusion 111 from moving along the vertical direction. The position limiting block 115 is accommodated in the through slot 39, and the position limiting block 115 abuts against the position limiting portion 391. After the grounding member 3 is assembled on the insulating member 11, the position limiting block 115 may be liquefied by ways such as a laser, and the liquefied position limiting block 115, after cooling, will attach on the grounding member 3 to limit the grounding member 3 from moving along the vertical direction and the front-rear direction. If the volume of the position limiting block 115 is sufficient, it may further limit the grounding member 3 from moving along the left-right direction, thereby fixing the insulating member 11 and the grounding member 3.

The quantity of the elastic arms 37 may be adjusted. For example, each base 36 may form two elastic arms 37 extending in the vertical direction at positions related to a corresponding ground terminal 21, one of the elastic arms 37 abuts against the body portion 210, and the other elastic arm 37 abuts against the elastic portion 211 or the main body 31. When each base 36 correspondingly form an elastic arm 37 extending in the vertical direction, the slots 112 are provided at positions corresponding to the elastic arms 37 below, and the elastic arms 37 are one-to-one correspondingly accommodated in the slots 112. In the direction from one end of the elastic arm 37 connected to the base 36 toward the abutting region 371, the width of each slot 112 is reduced. It should be noted that, in other embodiments, if a row of terminals are directly clamped and fixed in the insulating shell 10, the slots 112 and the position limiting protrusions 111 may be provided on the insulating shell 10 according to the needs, and the present invention is not limited thereto.

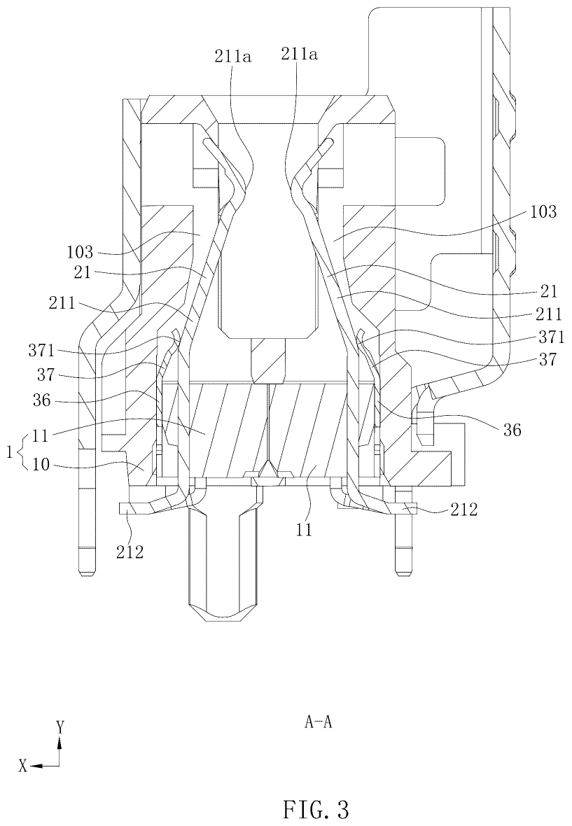

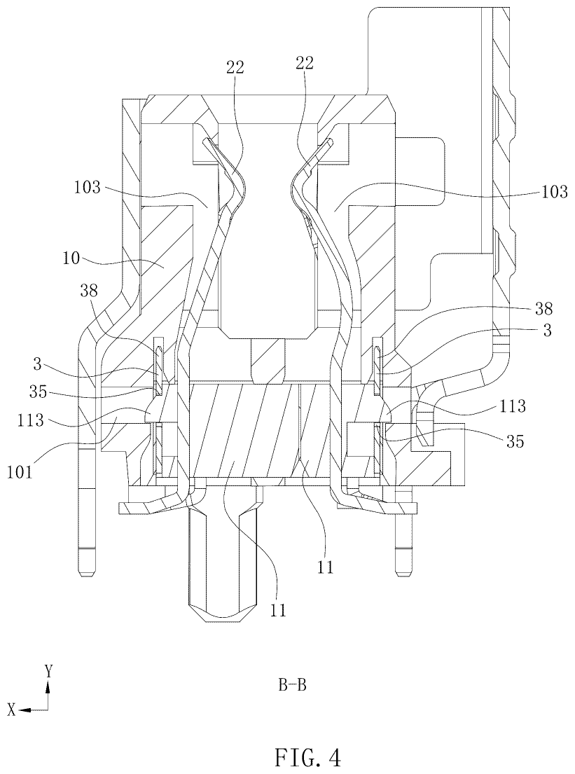

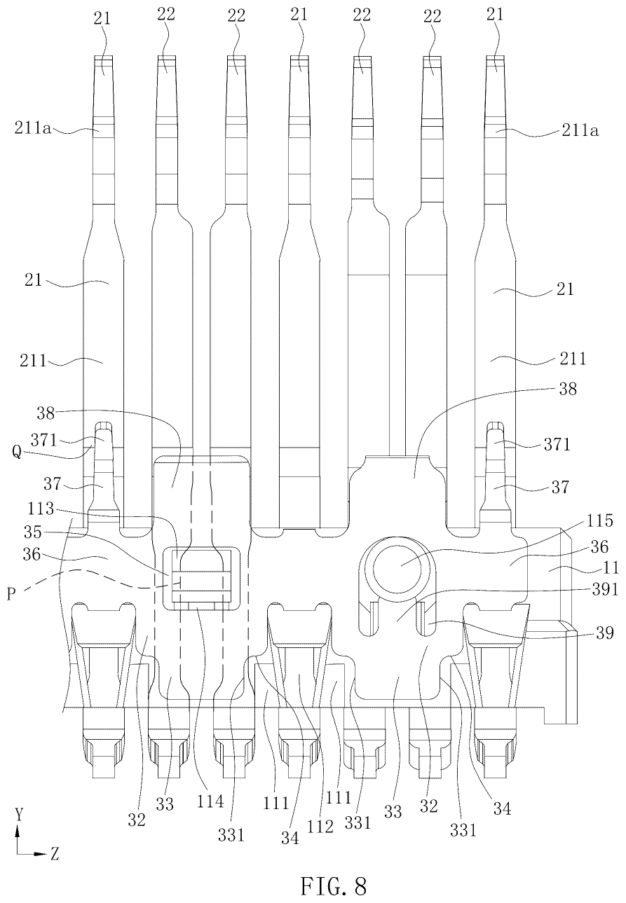

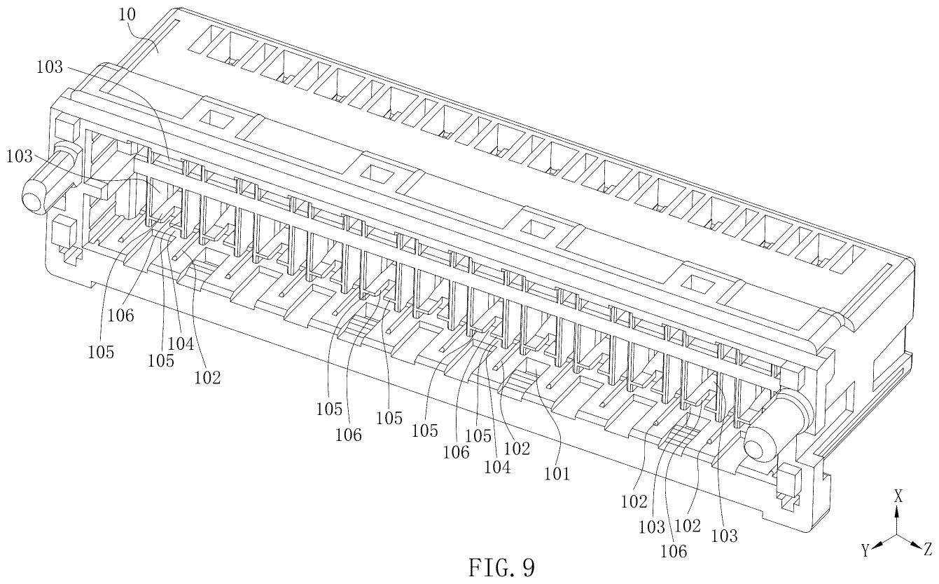

As shown in FIG. 1, FIG. 8 and FIG. 9, the insulating body 1 is further provided with a recess 114, and each of the pair of differential signal terminals has an exposing portion P located in the same recess 114. The grounding member 3 correspondingly shields the two exposing portions P of the pair of differential signal terminals. Referring to FIG. 4, to further enhancing the internal space usage and stability of the electrical connector 100, the insulating shell 10 has a first opening 101, the grounding member 3 has a second opening 35 in communication with the first opening 101, the insulating member 11 has a clamping block 113, and the clamping block 113 is limited in the first opening 101 and the second opening 35. Referring to FIG. 3, an inner wall of the insulating body 1 is provided with a plurality of protruding ribs 102. The protruding ribs 102 are located at a side of the bases 36 away from the ground terminals 21, and the protruding ribs 102 abut against the bases 36 toward the ground terminals 21.

In sum, the present invention has the following beneficial effects:

1. In the electronics field, according to the transmission needs, the electrical connector 100 is used to perform signal transmissions within a target frequency range, and to prevent from unwanted resonant interference within the target frequency range (generally the resonant interference is generated by the grounding module, and is hereinafter referred to as the grounding module resonance), the present invention reduces the resonance and reduces the interference between the signals by adjusting the structure of the grounding module, which will be described hereinafter in details. When the wavelength of the electrical connector 100 at a specific frequency is an odd multiple of a quarter wavelength of the target frequency, the grounding module resonance occurs, and the grounding module resonance prevents the electrical connector 100 from filtering out the noise and interference generated by the grounding module resonance at the signal receiving end. In the present invention, one of the two ground terminals 21 of each of two closest terminal pairs 2a is electrically connected to the grounding member 3, thereby adjusting the resonant frequency outside the target frequency range and eliminating the grounding module resonance. Further, in the present invention, the other of the two ground terminals 21 in each of the two closest terminal pairs 2a is electrically isolated from the grounding member 3. In other words, of the ground terminals 21 located at the left side and the right side of a pair of differential signal terminals or a single-ended signal terminal, one is electrically connected to the grounding member 3, and the other is electrically isolated from the grounding member 3. Thus, the noise and interference caused by the electric field and the magnetic field generated by the tiny currents and voltages on the ground terminals 21 do not concentrate on the pair of differential signal terminals or the single-ended signal terminal, and the interference experienced by the pair of differential signal terminals or the single-ended signal terminal is correspondingly reduced, thus optimizing the high frequency characteristics of the electrical connector 100 and enhancing the signal completeness of the electrical connector 100. In addition, one of the two ground terminals 21 of each of two closest terminal pairs 2a is electrically connected to the grounding member 3 and the other is electrically isolated from the grounding member 3, such that the electrical connection and electrical isolation between the grounding member 3 and the ground terminals 21 in the left-right direction are regular and periodic, thereby resulting in a more uniform distribution of the electric field and the magnetic field generated by the ground terminals 21 and the grounding member 3 within the electrical connector 100, and optimizing the overall resonance of the electrical connector 100.

2. The position limiting protrusions 111 of the insulating body 1 match with the side end surfaces 331 and the step surfaces 34 of the grounding member 3, thereby limiting the movement between the grounding member 3 and the insulating member 11 along the left-right direction and the vertical direction, and ensuring the accurate contact between the grounding member 3 and the insulating member 11.

3. The insulating body 1 has the slots 112 exposing the ground terminals 21, the elastic arms 37 of the grounding member 3 are accommodated in the slots 112, and the abutting regions 371 of the elastic arms 37 abut against the ground terminals 21. The width of each slot 112 is reduced in a direction from one end of the elastic arm 37 connected to the base 36 to the abutting region 371, such that the slot 112 may limit the movement of the abutting region 371 thereof at the abutting region 371 of the elastic arm 37, thereby ensuring that, even though the abutting region 371 has a slight movement, it may be accurately connected to the corresponding ground terminal 21.

4. The clamping block 113 of the insulating member 11 is limited in the first opening 101 and the second opening 35, such that the fixing between the insulating body 1, the insulating member 11 and the grounding member 3 is resolved merely by the same clamping block 113, thus simplifying the assembly steps, reducing the complexity of the electrical connector 100, and enhancing the space usage within the electrical connector 100.

5. The protruding ribs 102 abut against the bases 36 toward the ground terminals 21, thereby ensuring the stability of the electrical connection between the elastic arms 37 and the ground terminals 21.

6. The exposing portions P of the pair of differential signal terminals are coupled at the recess 114 (and the coupling medium is the air, which is different from the material of the insulating member 11) to adjust and optimize the impedance matching thereof, and the grounding member 3 further shields the exposing portions P of a pair of the differential signal pairs located in the recess 114, thereby shielding and absorbing the noise and interference generated outward by the exposing portions P in the transmission process of the signals, optimizing the shielding effect, and enhancing the signal completeness of the electrical connector 100.

7. Along the left-right direction, a through hole 106 is provided between the terminal slot 103 and the accommodating slot 104 to communicate the two slots, and a protruding portion 105 is provided at each of the left side and the right side of the through hole 106. Each protruding portion 105 is located between one signal terminal of the pair of differential signal terminals and the shielding portion 38, thus separating the shielding portion 38 and the pair of differential signal terminals and preventing the two from being in contact with each other and short-circuiting. A portion of the pair of differential signal terminals and a portion of the shielding portion 38 overlap with the through hole 106 vertically, such that the air medium exists between the overlapping portions, which is a material different from the materials of the insulating member 11 or the insulating shell 10, such that the portion of the shielding portion 38 exposed in the air medium absorbs more energy (noise and interference) from the pair of the differential signal terminals, thereby optimizing the high frequency characteristics and enhancing the signal completeness of the electrical connector 100.

8. When the contact portion 211a of the elastic portion 211 abuts forward against the mating component, the elastic portion 211 moves toward the elastic arm 37, thereby strengthening the abutting force between the ground terminal 21 and the elastic portion 211 and ensuring the stability of the electrical connection between the grounding member 3 and the ground terminal 21.

9. The grounding member 3 includes a position limiting portion 391 provided to protrude from a peripheral wall of the through slot 39 toward an inner portion of the through slot 39, and the position limiting portion 391 is elastic. When one or both of the grounding member 3 and the insulating body 1 are subjected to an external force to move relative to each other, the position limiting portion 391 with elasticity may allow the grounding member 3 and the insulating member 11 to have certain moving space, thus providing the buffering function, preventing the position limiting block 115 with less hardness from damaging when the external force is excessively large and reducing the usage life of the electrical connector 100. Further, the position limiting block 115 may be liquefied, such that the liquefied position limiting block 115, after cooling and solidification, limits the grounding member 3 from moving along the vertical direction and the front-rear direction, thereby preventing the grounding member 3 from moving vertically and detaching from the insulating member 11 toward a direction away from the insulating member 11.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, comprising:
an insulating body;
a row of terminals, accommodated in the insulating body and comprising at least four terminal groups, wherein each terminal of the row of terminals has a contact portion configured to be in contact with a mating component, the contact portions of the row of terminals are arranged side-by-side in a left-right direction, each of the terminal groups is formed by a ground terminal and a pair of differential signal terminals or a single-ended signal terminal located at a side of the ground terminal, and along the left-right direction, the ground terminal and the pair of differential signal terminals or the single-ended signal terminal are arranged in an identical sequential order, and no ground terminal exists between each two of the terminal groups; and
a grounding member, serially connected to a plurality of the ground terminals in the row of terminals, wherein in the two ground terminals of each two of the terminal groups closest to each other, one of the two ground terminals is in electrical contact with the grounding member, and the other of the two ground terminals is electrically isolated from the grounding member.

2. The electrical connector according to claim 1, wherein the four terminal groups are arranged along the left-right direction as one ground terminal, one pair of differential signal terminals, one ground terminal, one pair of differential signal terminals, one ground terminal, one pair of differential signal terminals, one ground terminal, and one pair of differential signal terminals, and no terminal exists between each two of the terminal groups.

3. The electrical connector according to claim 1, wherein the grounding member has a plurality of elastic arms and a base directly connected to the elastic arms, the insulating body is provided with a plurality of slots at positions corresponding to the elastic arms, the elastic arms are one-to-one correspondingly accommodated in the slots, each of the elastic arms has an abutting region configured to abut against the ground terminal, and a width of each of the slots reduces in a direction from one end of each of the elastic arms connected to the base toward the abutting region.

4. The electrical connector according to claim 1, wherein an inner wall of the insulating body is provided with a plurality of protruding ribs, the grounding member comprises an elastic arm and a base directly connected to the elastic arm, the elastic arm abuts against the ground terminal, the protruding ribs are located at a side of the base away from the ground terminal, and the protruding ribs abut against the base toward the ground terminal.

5. The electrical connector according to claim 1, wherein the ground terminal comprises a main body, an elastic portion bending and extending from one side of the main body and a pin formed by bending and extending from another side of the main body, the contact portion is provided on the elastic portion, the pin is electrically connected to a printed circuit board (PCB), the ground terminal has only a contact region electrically connected to the grounding member, and the contact region is located on the elastic portion.

6. The electrical connector according to claim 1, wherein each of the terminal groups is formed by the ground terminal and the pair of differential signal terminals, the signal terminals of each of the terminal groups are a pair of differential signal terminals, the grounding member comprises a main body and a shielding portion formed by extending from the main body, the insulating body comprises a terminal slot accommodating the pair of differential signal terminals and an accommodating slot accommodating the shielding portion, a through hole communicating the accommodating slot and the terminal slot and two protruding portions respectively located at a left side and a right side of the through hole exist between the accommodating slot and the terminal slot, and a portion of the pair of differential signal terminals and a portion of the shielding portion overlap with the through hole vertically.

7. The electrical connector according to claim 1, wherein the grounding member is provided with a through slot and a position limiting portion provided to be elastic and protrude from a peripheral wall of the through slot toward an inner portion of the through slot, the insulating body comprises a position limiting block, the position limiting block is accommodated in the through slot and abuts against the position limiting portion, and the position limiting block is liquefied such that the position limiting block after cooling and solidification limits the grounding member from moving along a vertical direction and a front-rear direction.

8. The electrical connector according to claim 1, wherein the insulating body has a recess, each of the pair of differential signal terminals has an exposing portion located in a same one of the recess, and the grounding member correspondingly shields the two exposing portions of the pair of differential signal terminals.

9. An electrical connector, comprising:
an insulating body;
a grounding member; and
a row of terminals, accommodated in the insulating body arranged side- by-side in a left-right direction, wherein the row of terminals comprise a plurality of terminal sets, each of the terminal sets has two ground terminals at outer edges in the left-right direction and at least one signal terminal in a middle thereof, and along the left-right direction, the two ground terminals and the at least one signal terminal of each of the terminal sets are arranged in an identical sequential order;
wherein the grounding member is serially connected to a plurality of the ground terminals in the row of terminals, and in the two ground terminals of each of the terminal sets at the outer edges in the left-right direction, one of the two ground terminals is in electrical contact with the grounding member, and the other of the two ground terminals is electrically isolated from the grounding member.

10. The electrical connector according to claim 9, wherein the grounding member has a plurality of elastic arms and a base directly connected to the elastic arms, the insulating body is provided with a plurality of slots at positions corresponding to the elastic arms, the elastic arms are one-to-one correspondingly accommodated in the slots, each of the elastic arms has an abutting region configured to abut against the ground terminal, and a width of each of the slots reduces in a direction from one end of each of the elastic arms connected to the base toward the abutting region.

11. The electrical connector according to claim 9, wherein the grounding member comprises a main body, the main body comprises a first portion and a second portion formed by extending from the first portion, the first portion has at least one step surface facing downward, the second portion has a side end surface facing toward at least one side in the left-right direction, the insulating body has a position limiting protrusion, the side end surface limits the position limiting protrusion from moving along the left-right direction, and the step surface limits the position limiting protrusion from moving upward.

12. The electrical connector according to claim 9, wherein the insulating body has a recess, the at least one signal terminal of each of the terminal sets includes a pair of differential signal terminals, each of the pair of differential signal terminals has an exposing portion located in a same one of the recess, and the grounding member correspondingly shields the two exposing portions of the pair of differential signal terminals.

13. The electrical connector according to claim 9, wherein the at least one signal terminal of each of the terminal sets includes a pair of differential signal terminals, the grounding member comprises a main body and a shielding portion formed by extending from the main body, the insulating body comprises a terminal slot accommodating the pair of differential signal terminals and an accommodating slot accommodating the shielding portion, a through hole communicating the accommodating slot and the terminal slot and two protruding portions respectively located at a left side and a right side of the through hole exist between the accommodating slot and the terminal slot, and a portion of the pair of differential signal terminals and a portion of the shielding portion overlap with the through hole vertically.

14. The electrical connector according to claim 9, wherein the grounding member is provided with a through slot and a position limiting portion provided to be elastic and protrude from a peripheral wall of the through slot toward an inner portion of the through slot, the insulating body comprises a position limiting block, the position limiting block is accommodated in the through slot, and the position limiting block abuts against the position limiting portion to limit the position limiting portion from moving.

15. The electrical connector according to claim 9, wherein the at least one signal terminal of each of the terminal sets includes a pair of differential signal terminals, the row of terminals are arranged in the sequential order along the left-right direction as one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, one ground terminal, one pair of differential signal terminals, and one ground terminal.
